(19) United States
(12) Patent Application Publication
(10) Pub. No.: US 2007/0198551 A1
(43) Pub. Date: Aug. 23, 2007

(54) MULTI-CHANNEL AUDIO DATA DISTRIBUTION FORMAT, METHOD AND SYSTEM

(75) Inventors: Oliver Barnes, London (GB); Harry Richardson, London (GB)

Correspondence Address: DARBY & DARBY P.C., P.O. BOX 770, Church Street Station, New York, NY, 10008-0770, US

(73) Assignee: U-MYX LIMITED, London (GB)

(21) Appl. No.: 11/668,231

(22) Filed: Jan. 29, 2007

Related U.S. Application Data
(63) Continuation-in-part of application No. PCT/GB05/03001, filed on Jul. 29, 2005.

(30) Foreign Application Priority Data
Jul. 30, 2004 (GB) 0417099.9
Jan. 11, 2005 (GB) 0500494.0

(51) Int. Cl. G06F 7/00

(52) U.S. Cl. 707/100; 707/102

(57) ABSTRACT

Multi-Channel Audio Data Distribution Format, Method and System A system, method and data object enabling manipulation of multi-channel audio are disclosed. Track objects defining the multi-channel audio and are linked to a number of subtrack objects, each subtrack object corresponds to a channel of the multi-channel audio and including data linking the subtrack object to the respective channel in a corresponding multi-channel data file, each subtrack object being linked to a number of section objects. Each section object corresponds to a unique set of samples of the respective channel and defining a manipulable object enabling alteration of output of the multi-channel audio. The multi-channel audio data can be augmented from external sources.

### FIELD OF THE INVENTION

The present invention relates to a system, method and data format for generation and distribution and augmenting of multi-channel audio.

### BACKGROUND OF THE INVENTION

The terms “song” and “channel” are used throughout this document. Although various definitions for these terms exist in the art, in the case of the present invention, their intended definitions include:
Song: a single finished music or audio piece having a predetermined start and end. A music album would comprise one or more songs (typically each track being a self-contained song). A song may not necessarily be stored as a single entity (it could be stored as a number of packets or data structures) but it would always be played from start to end (or from one point in time to another as controlled by the user). A song is linear in time, defining the relative moment in time when each predetermined song element is output. Note that the “song” need not be music and could be any audio piece.
Channel: a song is made up of a number of channels. A song may include a lyric channel, a drum channel, a bass guitar channel, a synthesizer channel etc. Each channel is linear in time and has the same predetermined start and end as the channel (or is padded with silence so as to have the same start and end). When the final song is produced, the channels are interleaved to produce what is effectively a single channel (the song)

Audio data, particularly music, is typically produced at a studio and recorded as tracks onto media such as a CD, DVD for distribution. In the case of digital audio data, instead of being recorded to media, each track is instead encoded into a predetermined format such as MP3 for subsequent distribution.

The content of the songs produced and subsequently recorded or encoded is controlled by the studio and/or artist. When a song is played it is the composition of channels, as determined by the studio and/or artist, that is heard irrespective of the tastes of the listener. At the time of producing the songs, the artist will typically have prepared a number of elements in the form of channels that include variations of lyrics, vocal styles and music from different instruments. For example, a drum backing beat may be selected from a number of different pre-prepared drum beat channels with the end song may incorporate one or more of the drum channels. Similarly, a bass guitar channel may, or may not, be included depending on the judgment of the studio and/or artist. Once the elements making up the final composition have been selected by the studio and/or artist, the selected channels are interleaved with respect to time to produce a single song audio data item that includes the various elements. Due to the interleaving process, the various channels in the song merge and cannot subsequently easily be separated.

Of the many lyrics and channels prepared, only a small selection may ever make it into the final composition with the remainder being discarded. In some cases, the studio or artist may include a number of different mixes of a track to include different compositions of channels.

Whilst various attempts have been made to make multi-channel audio data available to a user in a form that can be customised and/or manipulated, various problems have been encountered.

Multi-channel audio data is provided to a user in its raw form, as is illustrated in FIG. 1. In this form, a song is provided as the separate channels 20, 30 and 40 produced by the artist or studio prior to interleaving. The areas 50 represent silence. Whilst it is straightforward for additional channels to be provided in this manner, it is also straightforward for individual channels to be extracted and used for other purposes that the artist may not have intended.

Additionally, unless the original mix the artist wishes to provide is provided in its interleaved form is provided in addition to the separate channels, some form of definition would be needed so that the user's system can interleave the channels to produce the mix. Even if such a definition were to be provided and there existed software that could interpret the definition and apply it to the channels, the actual process of interleaving the data is not computationally straightforward and would require a relatively powerful computer limiting the application of the multi-channel data.

Given these problems and the commercial nature of the music business, it is unlikely that an artist or studio would simply release surplus material to the general public due to copyright issues. Whilst it is desirable that such material is made available for use, it is important that control over how the material is used remains with the artist or studio.

### STATEMENT OF INVENTION

According to one aspect of the present invention, there is provided a data object including data enabling manipulation of a multi-channel audio data file comprising:
a plurality of track objects defining the multi-channel audio of the multi-channel audio data file, each track object corresponding to a channel of the multi-channel audio and including data linking the track object to the respective channel in the multi-channel data file, each track object being linked to a number of section objects;
each section object corresponding to a unique set of samples of the respective channel and defining a manipulable object enabling alteration of output of the multi-channel audio.

The data object may further comprise one or more objects limiting manipulation in isolation and/or in combination of one or more of the section objects.

The data object may further comprise augmentation data arranged to interface or associate with predetermined parts of the data object.

The data object may further comprise a mix object defining predetermined manipulations of the section objects.

According to another aspect of the present invention, there is provided a method of augmenting multi-channel audio data comprising:
making available augmentation data, the augmentation data being arranged to interface or associate with predetermined parts of the multi-channel audio data to enable alteration of reproduction of the multi-channel audio data.

The augmentation data may include mix data redefining how one or more channels of the multi-channel audio data or parts thereof are reproduced.

The augmentation data may include one or more supplementary channels for the multi channel audio data.

A unique identifier may be associated with the multi-channel audio data and referenced in the augmentation data.

According to another aspect of the present invention, there is provided a system comprising a user interface arranged to:
load multi-channel audio data;
accept augmentation data; and,
output the multi-channel audio data augmented in dependence on the augmentation data.

The user interface may be arranged to accept user inputs to manipulate one or more predetermined sections of one or more channels of the multi-channel audio data and/or the augmentation data, wherein the user inputs affect subsequent output of the multi-channel audio data.

Aspects of the present invention may be implemented in computer program code, hardware, firmware or combinations thereof.

The present invention seeks to provide an audio data format, method and system enabling multi-channel audio to be generated, distributed and augmented. In this manner, a user is able to selectively play audio from the channels (without producing a complete interleaved track) and optionally augment audio data with alternate mixes or additional tracks. In a preferred embodiment, the user can optionally produce an interleaved song comprising selected ones of the channels for subsequent use in a standard music reproduction apparatus.

Preferred embodiments enable chains of audio data and definition data to be created so that additional material (add-on channels, alternate mixes, user defined mixes and the like) can be made available to a user via a different delivery medium or at a different time yet seamlessly interface with the original audio data. The original audio data need not be shipped with augmentation data preserving copyright and revenue streams and ensuring that only owners of the original audio data can use the augmentation data.

In addition, selected embodiments allow an artist, studio or the like to define “rules” enabling which channels and the like can be adjusted by a user. In this manner, limits on mixing can be imposed and potentially premium versions could be released that give the user more interaction potential.

Selected embodiments of the present invention are applicable for use with computing apparatus having limited resources such as PDAs, MP3 players, home PCs and the like. Limited resources, particularly memory, mean that large amounts of data cannot be stored simultaneously. In the case of a standard music song, this is addressed by loading the song in blocks into memory, playing the loaded blocks in order while overwriting the already played block(s) with subsequent blocks of the song.

Selected embodiments seek to provide “on the fly” access to multiple audio channels such that a user can mix in, or mix out, a channel during output of a song. It is not practical (or indeed possible given the limited resources in many devices) to store all the channels in memory. Furthermore, since the data may be stored on devices for which seeking is a slow operation, such as CD-ROM drives, the present invention seeks to provide a format that allows multi-channel audio to be played with as few disk seek operations as possible.

Such access could not be provided using a naive solution, such as concatenating RIFF-WAV files together, each RIFF-WAV file comprising a track block for a particular channel. This is because such an implementation would require as many file seek operations as channels each time a block of audio is loaded.

Preferably, the format is able to store the multi-channel audio in the spare space left over on a CD single (say less than 400 MB).

Preferably, the format allows efficient seeking to new positions in the audio stream in response to users interacting with the UI.

Preferably, the format is arranged such that access to and/or extraction of individual channels of audio data is restricted.

A preferred embodiment uses OGG encoding format for operations such as framing, synchronization, seeking and the like. Details of the OGG format can be found at www.xipf.org.

In an alternative embodiment of the present invention, data is divided into blocks of multi-channel audio of short duration (e.g. one second). Within a block, channels which remain silent for the block duration are not required. A block header records which audio channels have data stored within the block, allowing a file reader to determine which channels within the block correspond to which global channels, and also which global channels to not have data within the block, and which therefore must represent silences. This approach reduces the size of the packed encoding by between 25-40% in typical cases and avoids zero padding if one of the channels has a long silent passage.

Audio data may be encrypted to prevent extraction of individual channels for other uses. Either the player or the file itself contained a copy of any encryption keys used.

Note that blocking without interleaving could be used, and this would also work, providing the blocks were small enough to be loaded into memory. In such a case, each block would contain a block of data from each channel, one after the other, rather than with samples being interleaved. Whilst this would work just fine, it grows less attractive as the size of the data in the block becomes larger. On platforms with very limited memory (such as PDAs), this could force the use of very small blocks. As the block size decreases, however, the overhead of the block header increases relative to the size of the track data.

In another embodiment, in order to achieve smooth non-linear playback of Sections from slow-seeking media (such as CDROM), all audio data could be loaded into memory.

In order to fit a song's audio data into memory, a compressed format is preferably used (Ogg/Vorbis). Whilst this is not mandatory (we could equally well use uncompressed formats (such as RIFF/WAV)), it avoids placing large demands upon the memory size of the users' computers. None the less, embodiments of the present invention have sufficient flexibility to accommodate any format (compressed or otherwise) into the application at any time in the future.

In this embodiment, as the entire audio data in memory, the block loading scheme that is discussed below is no longer necessary. Audio tracks are therefore embedded directly into the song files as is.

### BRIEF DESCRIPTION OF THE DRAWINGS

Embodiments of the present invention will now be described in detail, by way of example only, with reference to the accompanying drawings in which:

FIG. 1 is a schematic diagram of a multi-channel audio track;

FIG. 2 is a screenshot of a player for use with a data format according to an embodiment of the present invention.

FIG. 3 is a schematic diagram of aspects of a data structure used in an embodiment of the present invention;

FIG. 4 is a schematic diagram illustrating aspects of the data structure of FIG. 3 in more detail;

FIG. 5 is a schematic diagram illustrating aspects of the data structure of FIG. 3 in more detail;

FIG. 6 is a flow diagram of the steps of loading a song from a data structure according to an embodiment of the present invention.

FIG. 7 is a schematic diagram of the multi-channel audio track of FIG. 1 being encoded in accordance with an embodiment of the present invention;

FIG. 8 is a schematic diagram of a global header for a track used in a data format according to an embodiment of the present invention; and,

FIGS. 9a-c are schematic diagrams of a block data structure used in a data format according to an embodiment of the present invention.

### DETAILED DESCRIPTION

FIG. 2 is a screenshot of an audio player for use with a data format according to an embodiment of the present invention. The player includes a user interface 100 allowing the user to decode and decrypt a received multi-channel audio file into its constituent channels 110-120. The user interface accepts selections from the user via a mouse or other selection means (not shown) to play the song using some or all channels (or selected sections of channels) and to add-in or remove channels before or during play.

Preferably, the user is able to “save” the mix/arrangement selected in a data file to allow the mix to be replayed at another time. Saving is achieved by encoding the user's channel selections and the like without needing to include the audio data and is discussed in more detail below.

In addition, the data file could be passed to other users who could also play the mix (subject to having the source audio data). Alternatively or in addition, the user interface also is arranged to generate a digital output file (for example an MP3 file) based on the currently selected channels to allow the mix to be distributed or played on a personal digital audio player. Optionally, the user's selections may be used to create an appropriately encoded ringtone for a mobile phone.

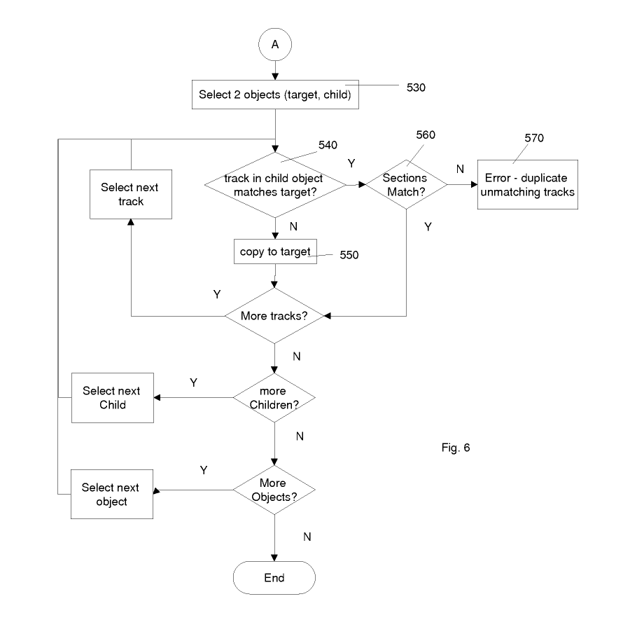

Various encoding formats are possible for the audio data itself, one of which is described below with reference to FIGS. 7 to 9. A preferred encoding scheme uses the OGG encoding format for audio data transportation.

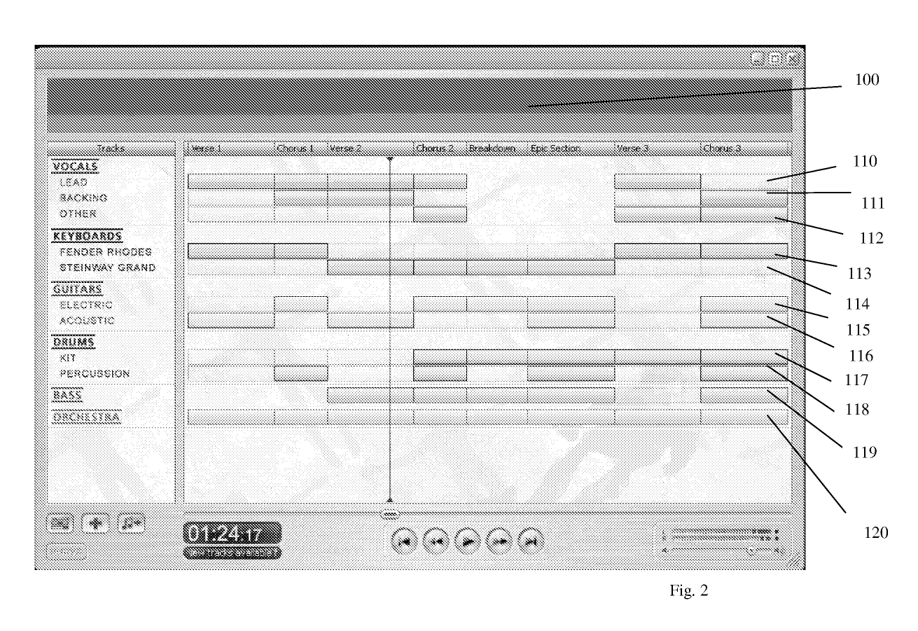

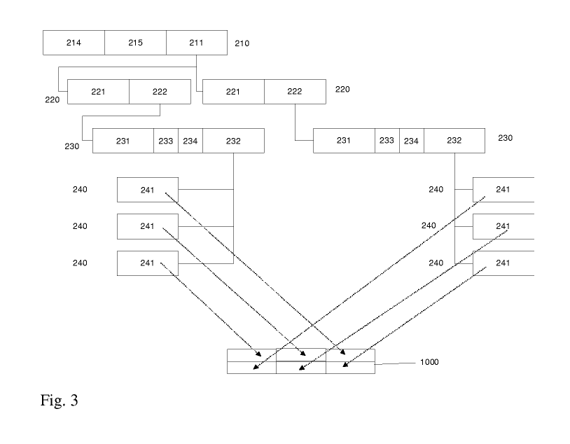

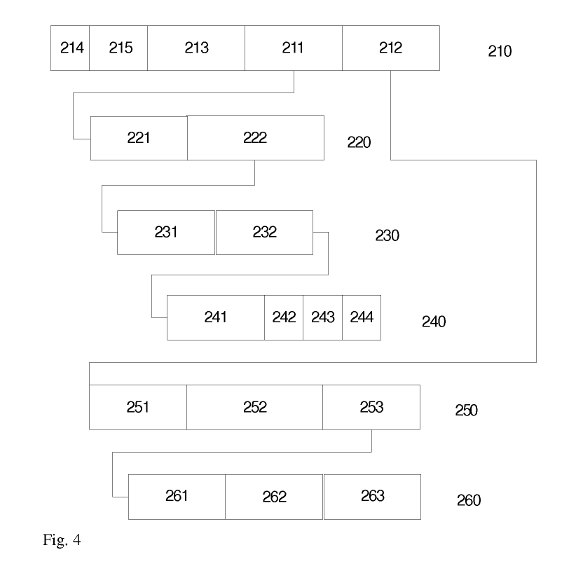

FIGS. 3 and 4 are schematic diagrams of aspects of a data structure used in a preferred embodiment of the present invention.

The data structure 200 is provided alongside encoded audio data such as that discussed above and encodes the information needed to recreate mixes (user created or otherwise) using the basic audio data. Any mixes created by a user would be stored in such a format, as would releases by others (including the original artist if desired). No audio data need be provided with mix data as the mix data would reference the original audio data. Additionally, the data structure 200 allows parent and child chains to be defined to enable augmentation data in the form of extra channels, tracks or mixes to be released or purchased after the original audio release and subsequently combined with the original audio. For example, a user may buy a track on a CD from a shop and subsequently download extra channels to augment the track on the CD.

Optionally, the data structure 200 may enable introduction of predetermined rules selected by the artist or studio and implemented via a rules system in the data structure and user interface to allow artists to place restrictions on the possible mix permutations of the audio data that would be permitted by the player. For instance, it allows an artist to avoid having single channels exposed—a requirement if they are worried about users using samples in the creation of their own works. (It is still possible for users to sample multiple tracks that have been mixed together, but this is vastly less useful for the purposes of sampling with regard to creating new works).

Another important reason for artist-specified restrictions is that they can prevent the playback of sections or parts that do not sound good together, or to enforce either/or type behavior for alternate takes.

FIG. 3 is a schematic diagram illustrating aspects of a data structure used in an embodiment of the present invention.

The data structure 200 is provided alongside encoded audio data 1000 and enables the user to mix or re-mix sections of the audio data using an interface such as that illustrated in FIG. 2.

The data structure 200 will vary depending on the particular audio data provided but typically will include a song object 210, at least one track object 220, at least one subtrack object 230 and at least one section object 240.

The song object 210 is the header of the data structure 200 and includes fields identifying the mix. Each track object 220 is linked to a collection of subtrack objects 230. Each subtrack object 230 corresponds to a single channel of the audio data. For example, there may be ‘Orchestra’ track object 220, which comprises ‘Violin’ and Cello’ subtrack objects 230.

Each subtrack object 230 includes fields for a filename 233, file type 234 and an offset 235 that collectively point to the audio data and enable the user interface to access the subtrack within the audio data.

Each subtrack object is linked to a collection of section objects 240. Each section object 240 defines a predetermined period in time (section) of the subtrack's respective audio channel. Sections are the smallest granularity that can be manipulated by a user using the user interface. For example, a single section of a channel may run from the 14,000^{th} sample to the 250,000^{th} sample. Links between the respective sections and the respective portion of audio data 1000 is shown by dotted lines (note that the audio data is not included in the objects and is just referenced and can be provided to and stored by the user separately).

It is not always necessary for the data structure 200 to include both track and subtrack objects. In one embodiment, the data structure 200 may include a plurality of track objects 220, each track object 220 including the features and functionality of a subtrack object discussed above.

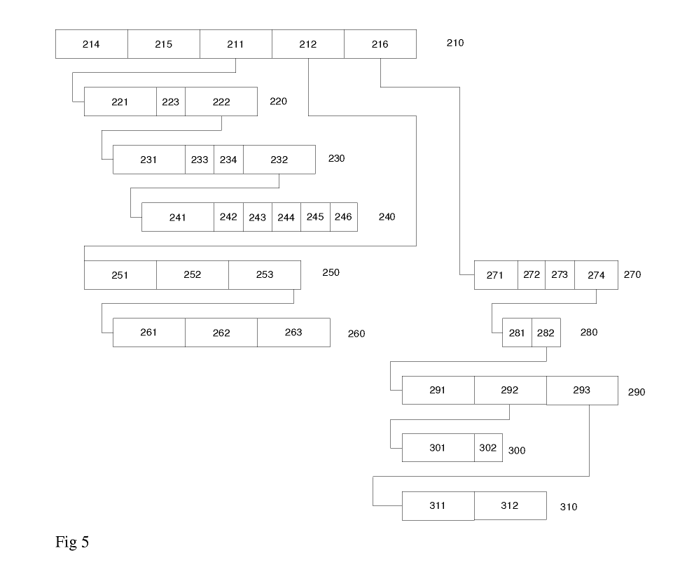

FIG. 4 illustrates aspects of the data structure 200 used by the rules system whilst FIG. 5 illustrates aspects of the data structure used for chaining and mix storage. It will be appreciated that the data structure 200 illustrated in FIGS. 4 and 5 are not mutually exclusive and implementations may include the described aspects of either or both data structures. Where like objects are referred to, an object from an implementation including both aspects would include data fields as described in FIGS. 4 and 5.

In the context of the rules system, a data structure will vary depending on the particular audio data provided but typically will include a song object 210, at least one track object 220, at least one subtrack object 230, at least one section object 240, at least one group object 250 and at least one limits object 260, as is illustrated in FIG. 4.

The song object 210 is the header of the data structure and includes a track_map field 211 linking to a set of track objects 220, addressed by name and a group_map field 212 linking to a set of group objects 250, addressed by name. The song object also includes a minimum_level field 213. Each subtrack may have volume adjustments made by the user (in the style of a multi-stage envelope, though this is not important from the perspective of rules). The minimum_level field 213 determines the range of possible volume adjustments by affecting the quietest volume to which the user can set a subtrack.

This minimum level is typically set to zero (allowing full control of the volume range) if the artist does not require rules, but is set to produce a minimum volume change of 5-10 dB from the original level if rules are required. This is to prevent circumvention of the rules system through use of the volume system.

Each track object 220 includes a name field 221 identifying the track and linking back to the respective song object 210 and a subtrack_map field 222 linking to a set of track objects 230, addressed by name.

Each subtrack object 230 includes a name field 231 identifying the subtrack and linking back to the respective track object 220 and a section_map field 232 linking to a set of section objects 240, addressed by name.

Each section object 240 includes a name field 241 identifying the section and linking back to the respective subtrack object 230, a group field 242 identifying the group to which this section belongs (this may be null if the section does not belong to a group) and a start and an end field 243, 244 identifying the number of samples into the song at which the section starts/ends. Each section may optionally belong to a group (with ownership being determined by having the group's name as the section's group field).

Each group object 250 includes a name field 251 identifying the group and linking back to the respective song object, a minimum field 252 defining a minimum number of active sections in this group and a limits_map field 253 linking to a set of limits objects 260, addressed by name. The minimum field 252 defines the minimum number of sections in the group that must be active at any time. The player will not allow the user to deactivate members of the group once that minimum level has been reached.

Each limits object 260 includes a maximum and minimum field 261, 262. Sections belonging to the both same track and the same group can have additional restrictions placed upon them; a minimum and maximum number of active sections can be specified by track for a given group. If the user attempts to deactivate a section which would take the number of active sections in its track and group below the minimum, the player will disallow it. If they attempt to take the number above the maximum, the player will select another section to deactivate automatically to keep the active number within the specified limits.

Optionally, a group may include a set of ‘do-not-expose’ sections. This set of sections are defined as ones which should not be played in isolation. This differs from the minimum volume levels already present in that if the do-not-expose sections were not active, it would have no effect. If at least one such section were active, however, the player would enforce that at least one other section in the group were active (whether it was a ‘do-not-expose’ section or not). The primary purpose of this mechanism would be for artists who were happy to expose anything to the user except for the vocal tracks, though other usages are possible. This mechanism would coexist with all previously mentioned rules.

Optionally, a section object may be linked to a number of part objects. Each part object defines a chunk of audio belonging to a track that can be enabled or disabled by a user.

FIG. 5 is a schematic diagram of aspects of a data structure used for chaining and mix storage.

The data structure 200 is provided alongside encoded audio data and implements a system enabling song-chaining such that dependencies between audio files can be defined. For example:
‘Add-on’ content packs could be released. For instance, a band's website might allow purchase and download of a data file containing an alternative vocal track sung by a guest artist. This new track will integrate with their existing release, which may be on CD-ROM, and appear to the user as a unified whole.
User-created mixes could be stored separately from the release data file. Mix data cannot simply be saved in the data file, since that may reside on a read-only device such as a CD-ROM. There are other ways in which mix data could be saved—for instance by creating a second file format to describe just mixes—but the chaining approach provides a single, unified method of handling this whilst also allowing new content to be provided. These user-created mix files are small, and can be easily shared between users, however since no audio data is embedded in them, they are of no use to those who have not purchased the songs files on which they depend.

The data structure 200 will vary depending on the particular audio data provided but typically will include a song object 210, at least one track object 220, optionally, one or more subtrack objects 230, at least one section object 240, at least one group object 250 and at least one limits object 260.

The song object 210 is the header of the data structure and includes a unique identifier field 214, a parent unique identifier field 215, a track_map field 211 linking to a set of track objects 220, addressed by name and a mix_map field 216 linking to a set of mix objects 270, addressed by name.

The unique identifier field 214 contains a Universally Unique Identifier (UUID) for the song. A UUID is preferably a 128 bit number (though it may be encoded as a string using any suitable encoding scheme, such as base64). 128 bits is large enough that it functions as ‘swiss number’—a number whose size is sufficiently large that many, many separate values may be picked at random with a vanishingly small chance that any two numbers are the same.

The parent unique identifier field 215 contains a unique identifier for the song's parent. This may be null if the song does not have a parent.

Each track object 220 includes a name field 221 identifying the track and linking back to the respective song object 210, a subtrack_map field 222 linking to a set of track objects 230, addressed by name and a ranking field 223 defining the position on screen at which the track will be presented to the user.

If subtrack obectes are used, each subtrack object 230 includes a name field 231 identifying the subtrack and linking back to the respective track object 220, a section_map field 232 linking to a set of section objects 240, addressed by name, a ranking field defining the position on screen at which the track will be presented to the user, an offset field 233 specifying the position of the audio data for the subtrack within the encoded audio data, and an encoding field 234 specifying the type of encoding used for the audio, allowing different encoding schemes to be used for different audio channels if desired. If subtrack objects are not used then the functionality of subtrack objects may be incorporated into track objects.

Each section object 240 includes a name field 241 identifying the section and linking back to the respective subtrack object 230, a start and an end field 243, 244 identifying the number of samples into the song at which the section starts/ends and a fade_in and fade_out field 245, 246 identifying the number of samples into the song at which the section starts to fade in/out if playback rules so dictate.

Each mix object 270 includes a name field 271 identifying the mix and linking back to the respective song object 210, a creator field 272 naming the author of the mix, a preset field 273 indicating whether the mix was created by the user or was part of a release, and a mix_track_map field 274 linking to a set of MixTrack objects 280, addressed by name.

Each MixTrack object 280 includes a name field 281 identifying the mix track and linking back to the respective mix object 270 and a mix_subtrack_map field 282 linking to a set of MixSubtrack objects 290, addressed by name.

Each MixSubtrack object 290 includes a name field 291 identifying the mix subtrack and linking back to the respective MixTrack object 280, a mix_section_map field 292 linking to a set of MixSection objects 300, addressed by name and a levels field 293 linking to a Levels object 310 for the mix subtrack.

Each MixSection object 300 includes a name field 301 identifying the mix section and linking back to the respective MixSubtrack object 290, an active field 302 indicating whether the section should be heard.

Each Levels object 310 includes a positions field 311 which is a vector of integer sample positions, sorted numerically and a values field 312 which is a vector of floating point volume values, corresponding to the positions field's vector.

New user-created mixes are saved as separate mix objects 270, but the mix that is saved does not contain any audio data.

In a preferred embodiment, a song's playback (in a given Mix) is described as a list of MixSections (and hence, by implicit reference, the Sections to which those MixSections refer). These MixSections may be inserted, deleted, copied and so forth in this list. The Sections themselves are immutable objects describing where in the audio to get the data.

To playback from a given time position, we first determine which section we are in. This is done by going through the list of MixSections, finding the corresponding Sections and adding up their lengths until one is found that brackets our position.

If a part hangs over the start or end of the section that contains it, it is normally allowed to extend into the preceding or succeeding section. However, if we are dealing with the first MixSection, then we shift it's start by the length of the biggest preceding overhang, so that the first part starts at zero, rather than some negative number. Similarly with the last section and parts hanging over the end.

Once the Mix Section, and hence the Section, has been determined, the Track objects are used to determine the audio source, and The Section start field to determine the offset into that audio. Finally the MixPart associated with the position within the section is used to determine whether the audio is enabled.

If a part hangs over the start of a MixSection such that it overlaps a part belonging to the preceding MixSection, then we move from one part to the other on the section boundary (using a short crossfade to mask the change).

In a preferred embodiment, new channels can be added to an existing track after the original track has been distributed. For instance, additional channels could be downloaded from an artist's website. In the preferred embodiment, the player merges the new channels data with the old.

In order to allow this merging to be automatic, each song object 210 includes the UUID field 214 and a parent unique identifier field 215 (containing the UUID of the parent). The parent identifier may be null, which indicates that the file does not depend on a parent file. Files are not allowed to be mutually dependent (so that no file may be both the ancestor and descendant, directly or indirectly of another single file).

When the player loads a file, it stores information about the file in an appropriate persistent storage system such as a database, the Windows Registry or Mac OS preferences file. This information includes the audio data file location and the parent identifier and a set of child identifiers (which will be empty initially). All of this information is indexed under the file's unique identifier.

After storing this information, the player determines the top-level root file for this song. A top-level root is a file which does not have a parent. If the file being loaded has no parent identifier, then it is the top level root. Otherwise, information about the parent is retrieved from the persistent storage mechanism, and this is checked to see if the parent itself has a parent, in which case we switch to that file. We repeat this procedure until the top-level root is found.

Having found the top-level root, the player loads it. The player then loads each of the root's child files by looking up the root's persistent information, retrieving the set of child identifiers, loading the information for each child identifier to determine child file locations, and then loading the child files themselves, merging their data into the top-level root. This same procedure is then recursively applied to the children, so that their children too are loaded and merged.

Entries in the persistent storage system are addressed by uuid, and will contain the following:

filename: the last known location of the data file containing the song;

parent: the parent-uuid of the song; and,

children: a set of uuids for child songs.

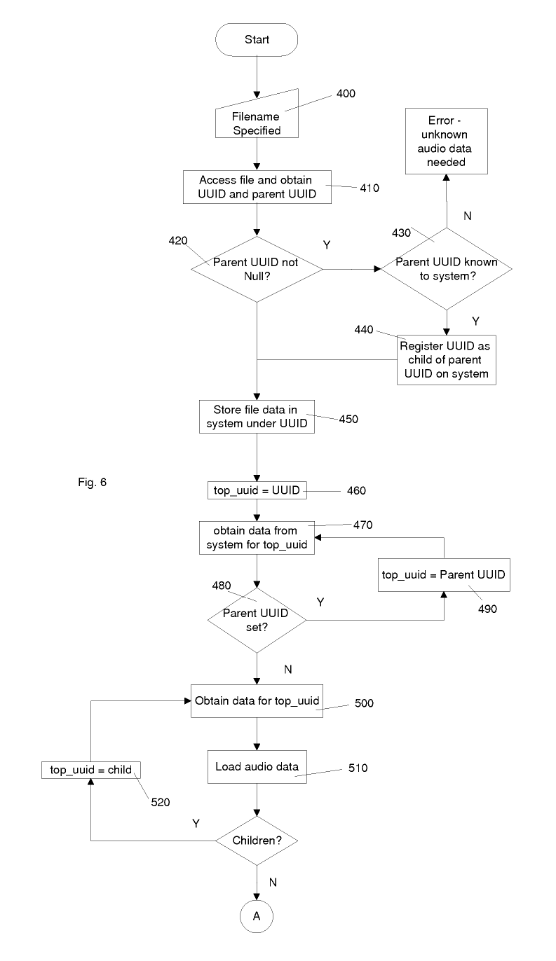

FIG. 6 is a flow diagram of the steps of loading a song from a data structure according to an embodiment of the present invention.

In step 400, a filename for new audio data material to be introduced is specified by a user.

The file corresponding to the filename is accessed in step 410 to obtain from it the uuid and parent-uuid of the song associated within it.

In steps 420, it is determined if the parent_uuid is not set to null. If the parent_uuid is set then in step 430 the persisent data store is searched for an entry stored under the parent_uuid to ensure the audio data upon which the file depends is stored on the system. If the parent_uuid is not found, then the necessary parent file has not been seen before by the system and an error is returned as insufficient files exits (for example, a new mix or bonus material may have been obtained for audio material that is not present on the system and therefore cannot be implemented).

In step 440, if the parent_uuid is found then the new material's uuid is added to the set of children under the parent_uuid in the persistent data store

In step 450, the filename and parent data entries for the new material is stored in the persistent data store under the uuid.

The root data file of the chain (the file whose data does not depend on any other files (and which will usually be the basic file included with the audio track on a CD-ROM)) is then determined. In step 460, a variable “top_uuid” is set to the uuid of the new material. In step 470, the data stored under “top_uuid” is obtained from the persistent data store. In step 480, it is determined if a parent UUID is defined in the data from the data store. If so, “top_uuid” is set in step 490 to the parent value and we loop back to step 470.

Once the root data file uuid is identified, we are ready to start loading data. Data is loaded recursively using a load routine that takes the uuid as an argument, and which returns a new Song object by doing the following:
In step 500, data from the persistent data store for the “top_uuid” is obtained.
In step 510, audio data identified from the data obtained in step 500 is loaded from disk, CD-ROM, the Internet or elsewhere.
In step 520, for each entry in the children section of the data obtained in step 500, steps 500 and 510 are repeated for the child uuid.

If step 500 is unable to locate a child's audio data file, the user is prompted to determine whether they wish to remove the child entry, search for the file in a different location, or abort. If they choose to search, step 510 is performed with respect to a location identified by the user, and the filename entry in the persistent data store is updated under the child uuid accordingly.

Once all song objects have been loaded in steps 500-520, they are merged together in turn to produce a single merged file. Preferably, this is done by augmenting the song object corresponding to the root uuid with its children, although no specific order of processing is necessary as all files will eventually be merged.

In step 530, two song objects are selected, a target file (which already contains data), and a child file, whose data we wish to incorporate into the target.

For each track in the child file:
In step 540, it is determined is no track of the same name exists in the target file and if so, it is copied added to the target file in step 550. This is achieved by recursively checking and copying each subtrack in the current child track and each section in the current child subtrack.
If a track already exists, it is compared down to individual sections against that stored by the target file in step 560 by comparing all the integer fields within it the section. An error is returned in step 570 if the 2 tracks do not match.

Eventually, the target file includes objects corresponding to all necessary components (tracks, augmentation tracks, mixes etc) allowing the augmented audio data to be output or manipulated as desired.

Copies of any Mix objects from child files are copied the target file and the augmented file is then ready for use.

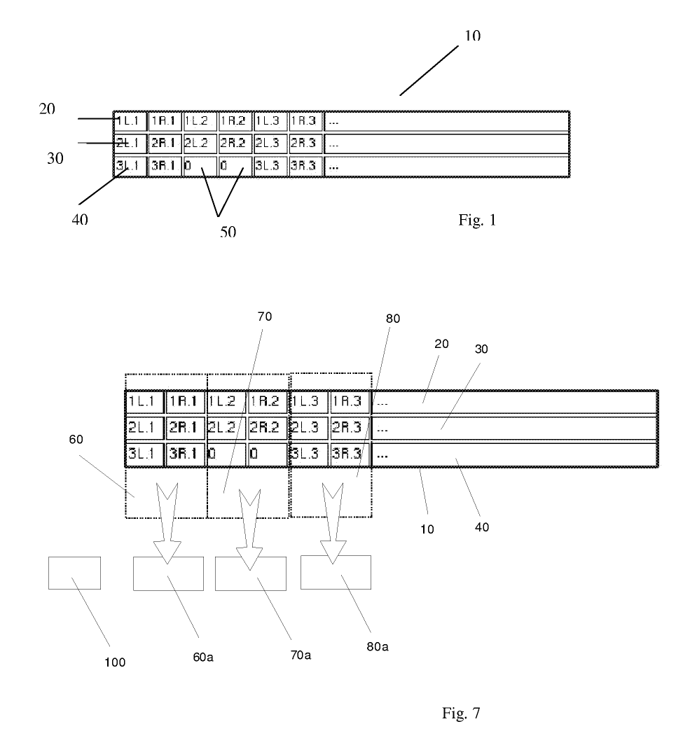

FIG. 7 is a schematic diagram of the multi-channel audio track of FIG. 1 being encoded in accordance with an embodiment of the present invention.

The track 10 is divided into blocks 60-80. A global header 100 is created for the track and this will be discussed in detail below. For each block 60-80, a block data structure 60a-80a details of the data structure will be discussed below. The portion of each channel 20-40 falling within the respective block 60-80 is encoded and encrypted and interleaved with portions from the other channels and stored in the respective block data structure 60a-80a.

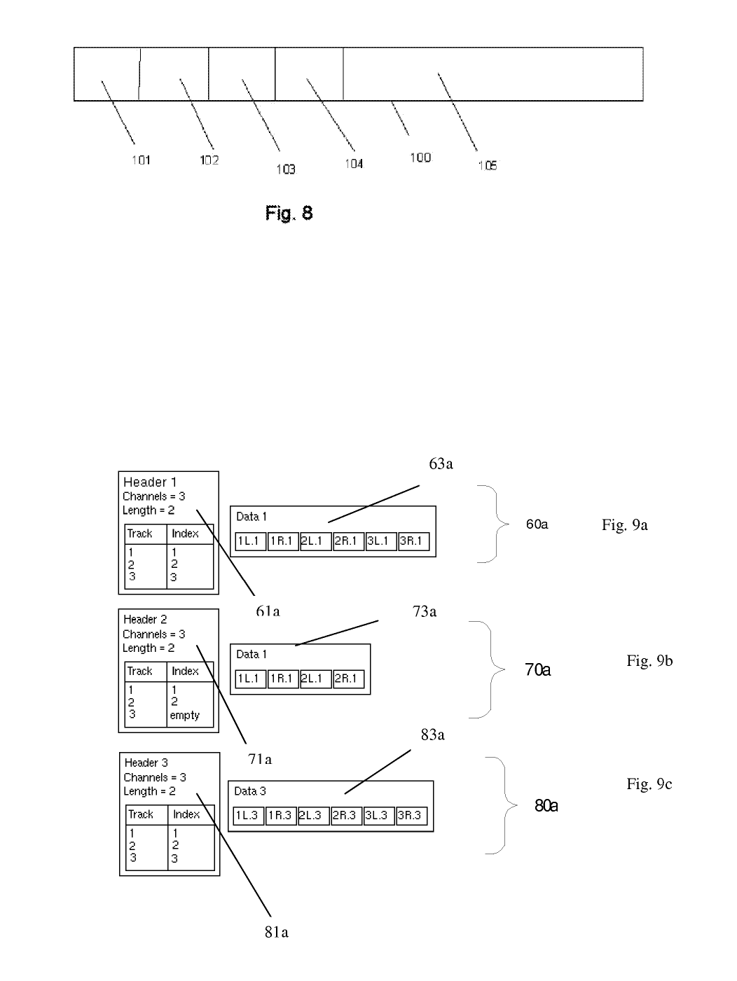

FIG. 8 is a schematic diagram of a block data structure used in a data format according to an embodiment of the present invention. An example of the block data structure 60a is shown, although it will be appreciated that the same type of data structure is used for all blocks 60-80.

The block data structure 60a includes a channel map field 61a, an encryption key field 62a and an audio data field 63a, each of the fields is discussed in detail in table 2. Note that the field sizes are merely examples and could be changed depending on the requirements of the particular implementation.

| Field | Size | Description |
|---|---|---|
| ChannelMap | 4 bytes * | Vector which provides the mapping from global channels to block-channels. The |
| | ChannelCount | first non-silent block-channel will be set to 0, the next non-silent block- |
| | | channel will be set to 1 and so forth. For channels which are silent in the |
| | | block, we record a specific constant to indicate the fact. |
| | | The reader can determine the number of non-silent block-channels by reading |
| | | this map and counting the number of entries which do not indicate silence. |
| | | Subsequently, this number will be referred to as BlockChannelCount. |
| EncryptionKey | 4 bytes * | Keys under which the individual block-channels are encrypted. The key does |
| | BlockChannelCount | not have to be limited to 4 bytes, but that fits the current encryption |
| | | algorithm of the player implementation. |
| AudioData | 4 bytes * | Interleaved audio data. The 4 byte size here is not specific; currently 16-bit, |
| | BlockChannelCount * | 44.1 KHz data is used, but this could trivially be extended to support |
| | BlockSize | other audio formats. |

Channel map field 61a maps from absolute channel number known from the global header's channel count field 104 to a channel number associated with the audio data field 63a for the respective block 60. If the portion of the channel contains silence, then its entry in channel map field 61a will be ‘empty’. Samples from non-silent channels are interleaved within audio data field 63a in left/right sequence and then in time order. Although one left and one right sample for each block is shown, this would depend on the size set by the block header. For instance, the header might say that it has a length of 44100, which would mean the block would contain a total of (44100*2(for stereo)*number of non-silent channels) samples.

FIGS. 9a-c are schematic diagrams of the block data structure 60a-80a populated with data from respective blocks 60-80.

In this example, there are three absolute channels (20, 30, 40). For the first and third blocks 60, 80, all channels are active and therefore the channel map fields 61a, 81a map the absolute channels to the same numbered channel in the audio data fields 63a, 83a.

For the second block 70, the third channel 40 is silent. The channel map field 61a therefore maps the first absolute channel 20 to channel 1 in the audio data field 73a and the second absolute channel 30 to channel 2 in the audio data field 73a. The third channel 40 is not present in the second block data structure 70a.

As discussed above, encryption of the data is preferred to deter extraction of individual audio channels for other uses. In a preferred embodiment, a 32-bit Linear Feedback Shift Register is used with a maximal-cycle generating polynomial to generate a weak stream cipher which can be exclusive-or'ed with the audio data of a single channel within a block.

The choice of an LFSR was made because they are cheap, and because the choice of polynomial can be hidden within the player, whilst the key resides in the file encoding. This would be a bad choice from a conventional cryptographic perspective, but since we are only seeking to make an adversary spend more effort reverse-engineering, it works well. A more conventional choice of algorithm (such as AES or 3DES) would not have the extra information embedded in the player, and thus would allow for easier reverse engineering, even though the algorithm itself would be far, far stronger. It will be apparent to the skilled reader that any encryption scheme could be substituted for that described.

1. A data object including data enabling manipulation of a multi-channel audio data file comprising:
a plurality of track objects defining the multi-channel audio of the multi-channel audio data file, each track object corresponding to a channel of the multi-channel audio and including data linking the track object to the respective channel in the multi-channel data file, each track object being linked to a number of section objects;
each section object corresponding to a unique set of samples of the respective channel and defining a manipulable object enabling alteration of output of the multi-channel audio.

2. A data object according to claim 1, further comprising one or more objects limiting manipulation in isolation and/or in combination of one or more of the section objects.

3. A data object according to claim 1, further comprising augmentation data arranged to interface or associate with predetermined parts of the data object.

4. A data object according to claim 1, further comprising a mix object defining predetermined manipulations of the section objects.

5. A method of augmenting multi-channel audio data comprising:
making available augmentation data, the augmentation data being arranged to interface or associate with predetermined parts of the multi-channel audio data to enable alteration of reproduction of the multi-channel audio data.

6. A method according to claim 5, wherein the augmentation data includes mix data redefining how one or more channels of the multi-channel audio data or parts thereof are reproduced.

7. A method according to claim 5, wherein the augmentation data includes one or more supplementary channels for the multi channel audio data.

8. A method according to claim 7, wherein a unique identifier is associated with the multi-channel audio data and referenced in the augmentation data.

9. A system comprising a user interface arranged to:
load multi-channel audio data;
accept augmentation data; and,
output the multi-channel audio data augmented in dependence on the augmentation data.

10. A system according to 9, wherein the user interface is arranged to accept user inputs to manipulate one or more predetermined sections of one or more channels of the multi-channel audio data and/or the augmentation data, wherein the user inputs affect subsequent output of the multi-channel audio data.
